(19) United States
(12) Patent Application Publication
(10) Pub. No.: US 2012/0303982 A1
(43) Pub. Date: Nov. 29, 2012

(54) ELECTRONIC DEVICE CONTROLLING SYSTEM AND METHOD

(75) Inventors: JYUN-DA LIAO, Tu-Cheng (TW); YUN-WEN SU, Tu-Cheng (TW)

(73) Assignee: HON HAI PRECISION INDUSTRY CO., LTD., Tu-Cheng (TW)

(21) Appl. No.: 13/457,917

(22) Filed: Apr. 27, 2012

(30) Foreign Application Priority Data
May 23, 2011 (TW) 100117892

(51) Int. Cl. G06F 1/26; G06F 15/16

(52) U.S. Cl. 713/310

(57) ABSTRACT

A cloud server of a data center being used to control electronic devices. The cloud server receives employee information from a client in electronic communication with the cloud server a first time. The cloud server notifies a power supply to power on electronic devices corresponding to an employee, in response to a determination that employee information matches identification information of the employee. The cloud server notifies the power supply to turn off the electronic devices corresponding to the employee when the cloud server receives the employee information from the client a second time.

### BACKGROUND

1. Technical Field

The embodiments of the present disclosure relate to cloud computing technology, and particularly to an electronic device controlling system and method of payment by identifying a fingerprint via cloud computing.

2. Description of Related Art

In most offices, people manually turns on light switches and their electronic devices (e.g, computers) when entering the office, and manually turns off the light switches and/or the electronic devices when leaving the office. However, some people may forget to turn off light switches and their electronic devices when they leave their offices at the end of the workday. This result in a waste of energy and increase cost to the company. Therefore, there is room for improvement in the art.

### BRIEF DESCRIPTION OF THE DRAWINGS

FIG. 1 is a system view of one embodiment of an electronic device controlling system.

FIG. 2 is a block diagram of one embodiment of a cloud server included in FIG. 1.

FIG. 3 is a flowchart of one embodiment of an electronic device controlling method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

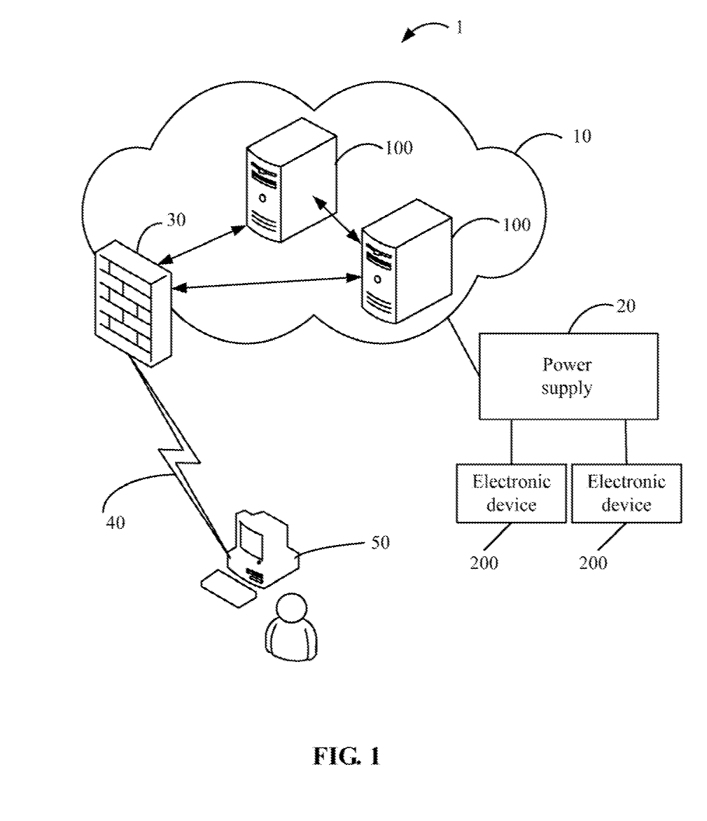

FIG. 1 is a block diagram of one embodiment of an electronic device controlling system 1. In this embodiment, the electronic device controlling system 1 may include a data center 10, a power supply 20, one or more electronic devices 200, a network 40 and one or more clients 50. The power supply 20 may be used to provide power to the electronic devices 200. The electronic devices 200 may be, but are not limited to, lamps, switchers, air conditioners, computers, or any other devices which are powered by the power supply 20. The electronic device controlling system 1 may be used to efficiently utilize electricity.

The data center 10 is located behind a firewall 30 and connected to the network 40. The network 40 may be, but is not limited to, a wide area network (e.g., the Internet) or a local area network. The firewall 30 is used to protect the data center 10 from unauthorized access and secure the information of the data center 10. The data center 10 is designed for cloud computing capability and capacity and includes a plurality of cloud servers 100. The cloud servers 100 are connected to the power supply 20 and notify the power supply 20 to cut off the power to the electronic device 200 in some situations. For example, if no one is present in the office, the cloud servers 100 may notify the power supply 20 to cut off the power to the lights and save the energy.

The cloud server 100 is a dynamic host configuration protocol (DHCP) server. In one embodiment, the cloud server 100 assigns IP addresses to the client 50. The cloud server 100 further sets a password (e.g., 123456$) and a name (e.g., apple) for enabling the client 50 to access the data center 10. The cloud server 100 also provides an access privilege for each client 50 according to the assigned IP address and the name. Additionally, the cloud server 100 may be a personal computer (PC), a network server, or any item of other data-processing equipment. Further details of the cloud server 10 will be described below.

The client 50 is connected to the network 40. The client 50 may be a personal computer (PC), a network server, or any item of data-processing equipment. For example, if the client 50 is a personal computer, the client 50 may provide a user interface for a user to access the data center 10 to control one or more operations of the cloud server 100. The user may input a password and a name by an input device (e.g., keyboard) into the user interface on a display device of the client 50 to access the data center 10. Depending on the embodiment, if the client 50 is an electronic time clock machine, a use may swipe his/her badge in the electronic time clock machine to access the data center 10.

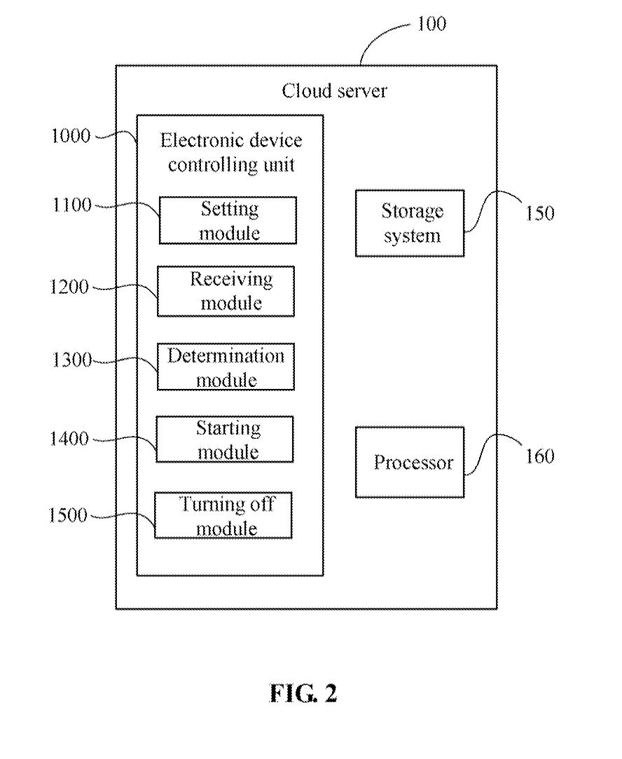

FIG. 2 is a block diagram of one embodiment of the cloud server 100. The cloud server 100 includes an electronic device controlling unit 1000. The electronic device controlling unit 1000 may be used to notify the power supply 20 to cut off the power to the electronic devices 200 when the electronic devices 200 are not turned off when they are supposed to. In one embodiment, the cloud server 100 includes a storage system 150, and at least one processor 160. In one embodiment, the electronic device controlling unit 1000 includes a setting module 1100, a receiving module 1200, a determination module 1300, a starting module 1400, and a turning off module 1500. The modules 1100-1500 may include computerized code in the form of one or more programs that are stored in a storage system 150. The computerized code includes instructions that are executed by the at least one processor 160 to provide functions for the modules 1100-1400. The storage system 150 may be a cache or a memory, such as an EPROM memory chip, hard disk drive (HDD), or flash memory stick.

The setting module 1100 sets identification information of an employee to access the cloud servers 100 of the data center 10. In one embodiment, the identification information includes a name of the employee, an employee identification number of the employee, an issued date of a badge issued to the employee, an expiration date of the badge, electronic device position information, and employee position information. In one embodiment, the electronic device position information is related to a position where the electronic devices 200 are installed and the employee position information is related to the place where the employee works. The identification information is also stored in the storage system 150. Additionally, the employee corresponds to one or more electronic devices 200 according to the employee position and the electronic device information. For example, assuming that an employee F1258 works at the position A and the electronic device (e.g., an air conditioner) are installed at the position B, if a distance between the position A and B is less than a predetermined distance (e.g., two meters), then the employee F1258 corresponds to the air conditioner.

The receiving module 1200 receives employee information from the client 50 a first time. In one embodiment, the employee information includes a name of the employee, an employee identification number of the employee, an issued date of a badge issued to the employee, an expiration date of the badge, electronic device position information, and employee position information.

The determination module 1300 determines if the employee information matches the identification information. In one embodiment, the determination module 140 compares the identification information that is stored in the storage system 180 with the employee information, if the identification information is the same as the employee information contained, the client 50 is permitted to access the cloud server 100 of the data center 10. Otherwise, if the identification information is different from the employee information, the client 50 is not permitted to login to the cloud server 100 of the data center 10.

The starting module 1400 powers on the electronic devices 200 corresponding to the employee, in response to a determination that the employee information matches the identification information. In one embodiment, the starting module 1400 notifies the power supply 20 to power on the electronic devices 200 corresponding to the employee. For example, the starting module 1400 notifies the power supply 20 to power on the air conditioner corresponding to the employee F1258.

The receiving module 1200 receives the employee information from the client 50 a second time. In one embodiment, the employee swipes his/her badge on the electronic time clock machine when he/she gets off work afternoon, for example at 5:30 PM, and the employee information is automatically sent to the cloud server 100.

The turning off module 1500 turns off the electronic devices corresponding to the employee. In one embodiment, the turning off module 1500 notifies the power supply 20 to cut off the electricity which is provided to the electronic devices 200 corresponding to the employee. For example, the turning off module 1500 notifies the power supply 20 to power off the air conditioner corresponding to the employee F1258.

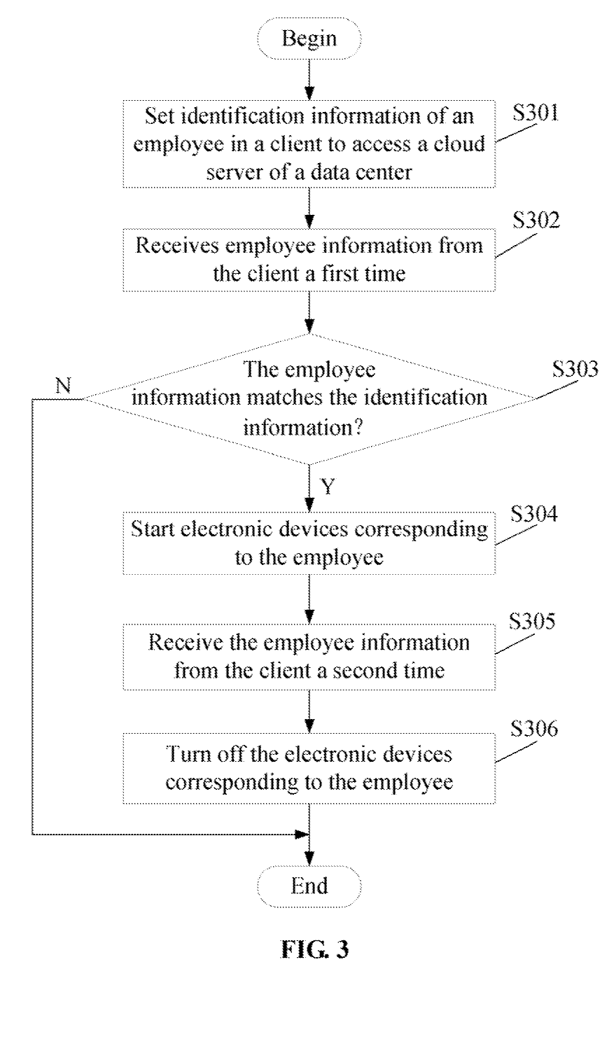

FIG. 3 is a flowchart of one embodiment of an electronic device controlling method. Depending on the embodiment, additional steps may be added, others deleted, and the ordering of the steps may be changed.

In step S301, the setting module 1100 sets identification information to access the cloud server 100 of the data center 10. As mentioned above, the identification information includes a name of an employee, an employee identification number of the employee, an issued date of a badge issued to the employee, an expiration date of the badge, electronic device position information, and employee position information.

In step S302, the receiving module 1200 receives employee information from the client 50 a first time. In one embodiment, the employee swipes his/her badge on the electrical time clock machine when he/she starts work in the morning, for example at 8:00 AM, and the employee information is automatically sent to the cloud server 100.

In step S303, the determination module 1300 determines if the employee information matches the identification information. In one embodiment, the determination module 140 compares the identification information that is stored in the storage system 180 with employee information, if the identification information is the same as the employee information contained, the client 50 is permitted to access the cloud server 100 of the data center 10, the procedure goes to step S304. Otherwise, if the identification information is different from the employee information, the client 50 is not permitted to the cloud server 100 of the data center 10, the procedure ends.

In step S304, the starting module 1400 powers on the electronic devices 200 corresponding to the employee, in response to a determination that the employee information matches the identification information. In one embodiment, the starting module 1400 notifies the power supply 20 to power on the electronic devices 200 corresponding to the employee.

In step S305, the receiving module 1200 receives the employee information from the client 50 a second time. As mentioned above, the employee swipes his/her badge on the electronic time clock machine when he/she gets off work afternoon, for example at 5:30 PM, and the employee information is automatically sent to the cloud server 100.

In step S306, the turning off module 1500 turns off the electronic devices corresponding to the employee. In one embodiment, the turning off module 1500 notifies the power supply 20 to cut off the electricity which is provided to the electronic devices 200 corresponding to the employee.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud server of a data center, the cloud server in electronic communication with a power supply, comprising:
a storage system storing identification information of an employee;
at least one processor; and
one or more programs stored in the storage system and being executable by the at least one processor, the one or more programs comprising:
a receiving module operable to receive employee information from a client in electronic communication with the cloud server a first time;
a determination module operable to determine if the employee information matches the identification information;
the starting module operable to notify the power supply to power on electronic devices corresponding to the employee, in response to a determination that the employee information matches the identification information;
the receiving module operable to receive the employee information from the client a second time; and
a turning off module operable to notify the power supply to turn off the electronic devices corresponding to the employee.

2. The cloud server of the data center of claim 1, wherein the identification information and the employee information comprises a name of the employee, an employee identification number of the employee, an issued date of a badge issued to the employee, an expiration date of the badge, electronic device position information, and employee position information.

3. The cloud server of the data center of claim 2, wherein the electronic device position information is related to a place where the electronic devices are installed.

4. The cloud server of the data center of claim 2, wherein the employee position information is related to a place where the employee works.

5. The cloud server of the data center of claim 1, wherein the client is selected from the group consisting of a personal computer, a network server and an electronic time clock machine.

6. An electronic device controlling method implemented by a cloud server of a data center, the cloud server in electronic communication with a power supply, the method comprising:
receiving employee information from a client in electronic communication with the cloud server a first time;
notifying the power supply to power on electronic devices corresponding to an employee, in response to a determination that the employee information matches identification information of the employee;
receiving the employee information from the client a second time; and
notifying the power supply to turn off the electronic devices corresponding to the employee.

7. The method of claim 6, wherein the identification information and the employee information comprises a name of the employee, an employee identification number of the employee, an issued date of a badge issued to the employee, an expiration date of the badge, electronic device position information, and employee position information.

8. The method of claim 7, wherein the electronic device position information is related to a place where the electronic devices are installed.

9. The method of claim 7, wherein the employee position information is related to a place where the employee works.

10. The method of claim 6, wherein the client is selected from the group consisting of a personal computer, a network server and an electronic time clock machine.

11. A non-transitory computer-readable medium having stored thereon instructions that, when executed by a cloud server of a data center, the cloud server in electronic communication with a power supply, causing the cloud server to perform an electronic device controlling method, the method comprising:
receiving employee information from a client in electronic communication with the cloud server a first time;
notifying the power supply to power on electronic devices corresponding to an employee, in response to a determination that the employee information matches identification information;
receiving the employee information from the client a second time; and
notifying the power supply to turn off the electronic devices corresponding to the employee.

12. The medium of claim 11, wherein the identification information and the employee information comprises a name of the employee, an employee identification number of the employee, an issued date of a badge issued to the employee, an expiration date of the badge, electronic device position information, and employee position information.

13. The medium of claim 12, wherein the electronic device position information is related to a place where the electronic devices are installed.

14. The medium of claim 12, wherein the employee position information is related to a place where the employee works.

15. The medium of claim 11, wherein the client is selected from the group consisting of a personal computer, a network server and an electronic time clock machine.
